(19) United States
(12) Patent Application Publication
(10) Pub. No.: US 2017/0129711 A1
(43) Pub. Date: May 11, 2017

(54) Equipment Isolation System

(71) Applicant: Remsafe Pty Ltd, Balcatta Western Australia (AU)

(72) Inventor: Michael Charles Lane, Dianella (AU)

(21) Appl. No.: 15/199,411

(22) Filed: Jun. 30, 2016

(30) Foreign Application Priority Data
Jun. 30, 2015 (AU) 2015902565

(51) Int. Cl. B65G 23/26

(52) U.S. Cl. CPC B65G 23/26

(57) ABSTRACT

An equipment isolation system (10) comprising at least one equipment item (20) including a conveyor belt (21) energisable by an energy source (30), an automated conveyor belt clamp system (21A) operable for restricting conveyor belt (21) movement from movement under normal operating conditions as part of the isolation and a control system (50,260) for automatically isolating said conveyor belt (21) from said energy source (30) to an isolated state in an isolation process wherein said control system (50,260) operates said automated conveyor belt clamp system (21A) as a step in said isolation process.

This invention relates to an equipment isolation system for isolating a conveyor belt system including operation of an automated conveyor belt clamp system as a step within an isolation process.

Various types of equipment must be isolated from a range of energy sources including electrical energy (the most common) and mechanical energy including pressure and potential energy to enable safe maintenance and other work to be carried out. Conveyor belt systems used in the mining industry for transporting iron ore or other bulk materials which can span significant distances are one such example of equipment which may require to be isolated from time to time.

The distances such conveyor belt systems can span can be in the range of many kilometres. Such conveyors are typically powered by electric drive motors: Three phase electrical power is supplied wherein the voltage may range from low voltage ranges (from below 600V to 1000V AC), to medium and high voltage ranges (in the multiple kV range and extending to above 10 kV AC and even 33 kV AC). Such conveyors typically include corresponding brake systems which are also electrically operated.

Although different mine procedures and relevant safety standards may apply, a typical pre-requisite before permitting mechanical maintenance or other activity involving access to the conveyor belt system involves the electrical isolation of the conveyor belt system. This isolation ensures that the energy source powering the conveyor belts and associated equipment, i.e. electrical power, is removed from systems or components that—if energised—could cause a safety hazard. It will however be understood that equipment items other than conveyor systems and other mining industry equipment also require isolation for maintenance and other purposes.

The isolation process is invariably safety critical and has, in the past, been time consuming, as described for example in the introduction to the Applicant's granted Australian Patent No. 2010310881 and International Publication No, WO 2012/142674, the contents of which are incorporated herein by way of reference.

The remote isolation system described in Australian Patent No. 2010310881 enables equipment isolation to be requested at a remote isolation station associated with the equipment and subsequently approved through a plant control system, without mandatory visitation to the equipment by authorised isolation personnel. This remote isolation system significantly reduces the time required to achieve safe isolation, and more specifically the production downtime that would normally be involved with such an isolation which can be very costly.

Whilst the Applicant's remote isolation system is very efficient and attractive to mining companies seeking to minimise the downtime of their plant critical equipment, certain applications may warrant further safety assurances being provided in respect of any isolations to be effected. This is partly due to the fact that, for a range of reasons, equipment may revert or be switched from an isolated state to an energised state when such a change in state is not desired and which in turn may result in one or more safety hazards. For example, equipment may accidentally be re-energised even though work on that equipment is intended or currently taking place.

Where conveyor belts are concerned, it is most important that risk of belt movement be minimised as far as possible. This typically involves using a clamp arrangement to prevent normal belt movement, i.e. movement to convey material as intended. One known solution involves manual clamping devices which need to be transported into sometimes elevated position and installed at spaced locations along the belt after the conveyor belt has been isolated. Installation of such a system is a time consuming and potentially unsafe process. Similarly, on de-isolation of the conveyor belt, the manual clamping devices need to be removed, again a time consuming and potentially unsafe process. Furthermore, there is a significant time impost on operability of the overall plant with at least several hours required for each process. This problem may be ameliorated by leaving manual clamping devices in position for use as required but, whilst this saves some time, the process is still time consuming. Manual clamping devices may also be too bulky to be positioned in the typically cramped environment of a conveyor belt system. Maintenance inspection may also present certain related cost problems.

Automated clamping systems may also be used but such systems have tended to be activated after isolation or de-isolation, involving a time consuming process with isolation personnel attendance as described in the introduction to the Applicant's granted Australian Patent No. 2010310881. In such arrangements, lost production time remains significant.

It is therefore an object of the present invention to provide a safer and more time and economically efficient isolation system for isolating conveyor belts which also incorporates a conveyor belt clamp system.

With this object in view, the present invention provides an equipment isolation system comprising:

at least one equipment item including a conveyor belt energisable by an energy source;

an automated conveyor belt clamp system operable for restricting conveyor belt movement from movement under normal operating conditions during isolation; and

a control system for automatically isolating said conveyor belt from said energy source to an isolated state in an isolation process wherein said control system operates said automated conveyor belt clamp system as a step in said isolation process.

Various belt clamp systems, as known in the art, may readily be integrated within the isolation system. Belt clamps, and more specifically their clamping members in the form of bars or plates, are driven into and out of clamping engagement with the conveyor belt by a suitable drive means such as an electric motor to restrict or prevent movement under normal operating conditions (i.e. the design conditions for the conveyor belt to perform its intended duty to convey material in and around the plant). An isolation system of this type which also includes an automated belt clamp system facilitates safe conveyor belt maintenance. Such maintenance may for example be to enable any belt splicing activities that may be required in respect of the conveyor belt. Such belt splicing typically needs to be done during an isolation and typically involves at least one belt clamp being positioned above, or corresponding to, the position of a belt splicing table or a specified position along the conveyor.

The equipment isolation system may implement steps to dissipate energy from an isolated, or to be isolated, conveyor belt system through stored energy tests prior to isolation. Conveyor belt systems including braking systems with brake(s) for slowing and stopping conveyor belt movement are just one example of an equipment item which may be monitored or checked for energy stored before being isolated. In such a case, the control system may command release of the conveyor brakes and then the conveyor belt may be monitored for movement. When the conveyor is confirmed stationary, the brakes will be re-applied. The brakes may then be released again with the conveyor belt again being continuously monitored for movement, with any such movement providing an indication of hazardous stored energy. This braking cycle procedure (in which brakes are released, applied, released and re-applied) may be repeated for as long, or as many times, as necessary until the control system confirms, through monitoring of conveyor belt movement and/or brake state, that the conveyor belt is completely stationary with all hazardous stored energy released or dissipated. Belt speed sensors and/or belt standstill monitors may conveniently be used for conveyor belt movement monitoring during such brake cycling but also during operation of the belt clamp system, such monitoring typically being continuous.

Monitoring of other parameters such as temperature and pressure may be relevant for certain conveyor belt systems, and also for other equipment items. For example, conveyor brake fluid pressure may be monitored to ensure that pressure is at a required set-point when the brakes are engaged and a corresponding conveyor belt is isolated.

The equipment isolation system also advantageously includes continuous monitoring of isolation integrity using one or more sensors, for example through monitoring of belt movement and clamp position both prior to and during an isolation event. Preferably, a plurality of sensors are used to increase safety assurance, for example as described in the Applicant's Australian Provisional Patent Application No. 2015902556, the contents of which are incorporated herein by way of reference. Monitoring by way of the one or more sensors is performed both prior to and during isolation.

At least one, and preferably a plurality, of the required sensors for continuous monitoring of isolation integrity should be selected from the group consisting of belt speed sensors, belt standstill monitors, belt slack monitors, belt clamp position sensors, braking system temperature sensors and braking system pressure sensors including brake fluid pressure sensors and brake fluid temperature sensors.

Storm clamps, designed to prevent conveyor belt loss through lifting from its rollers due to wind or storm damage and so distinguishable from the belt clamps just described, may also be automated and integrated within the isolation system if required.

The equipment isolation system may advantageously, but not exclusively, be operated in accordance with the Applicant's remote isolation systems which approve isolation on permissible request logged by an operator at a remote isolation station. Such systems and components are described, for example, in the Applicant's granted Australian Patent No. 2010310881 and the Applicant's Australian Provisional Patent Application Nos. 2015902554, 2015902556, 2015902557, 2015902558, 2015902559, 2015902561, 2015902562, 2015902564 and 2015902566 each filed on 30 Jun. 2015 , the contents of which are incorporated herein by way of reference. Remote isolation stations may be fixed, mobile or a combination of the two types.

The equipment isolation system as above described may usefully be applied to a range of equipment and processes whether on ‘greenfields’ sites or through retro-fitting. For example, and without intending limitation to the mining or quarrying industry, the equipment isolation system may isolate various types of belt conveyors for use in material handling processes.

The term “isolation” as used in this specification is to be understood in its maintenance engineering and legal sense as not simply turning off a supply of energy to equipment, whatever the nature of that energy, but removing and/or dissipating energy to provide a safe work environment as required by applicable occupational health and safety regulations. In the case of electricity, as just one example, isolation is not achieved simply by turning off a power supply to the equipment. In such cases, the equipment could accidentally re-start or be restarted and cause injury to personnel, or worse. Isolation instead prevents such accidental re-starting and typically will also involve processes to dissipate any hazardous stored energy, in whatever form that energy may take (e.g. potential energy), from the equipment. For example, such an additional energy dissipation step could be effected in respect of a conveyor belt system by way of the braking cycle procedure described herein.

The equipment isolation system may be more fully understood from the following description of preferred embodiments thereof made with reference to the following drawings in which:

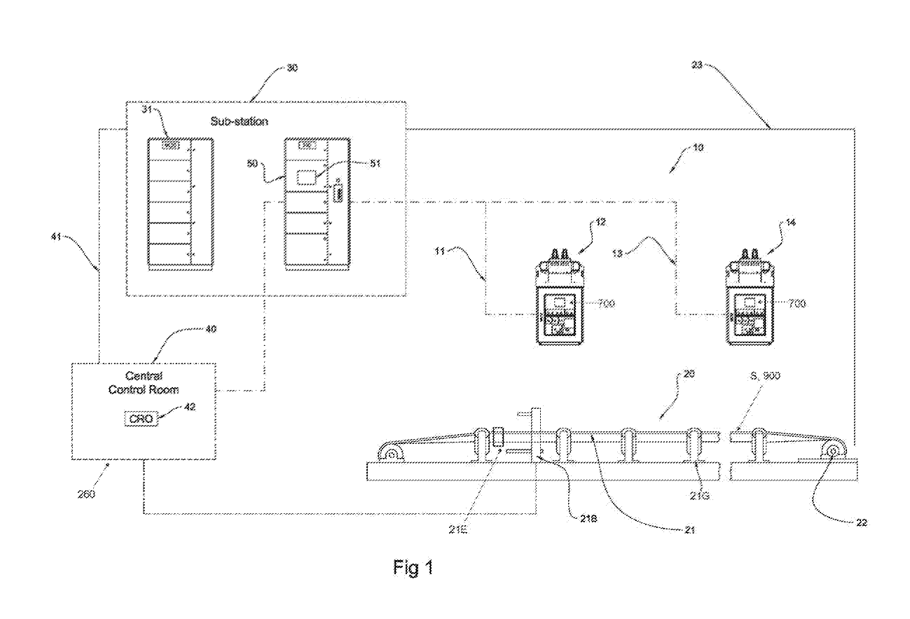

FIG. 1 shows a schematic layout of an isolation system as applied to a conveyor belt system in accordance with a preferred embodiment of the present invention.

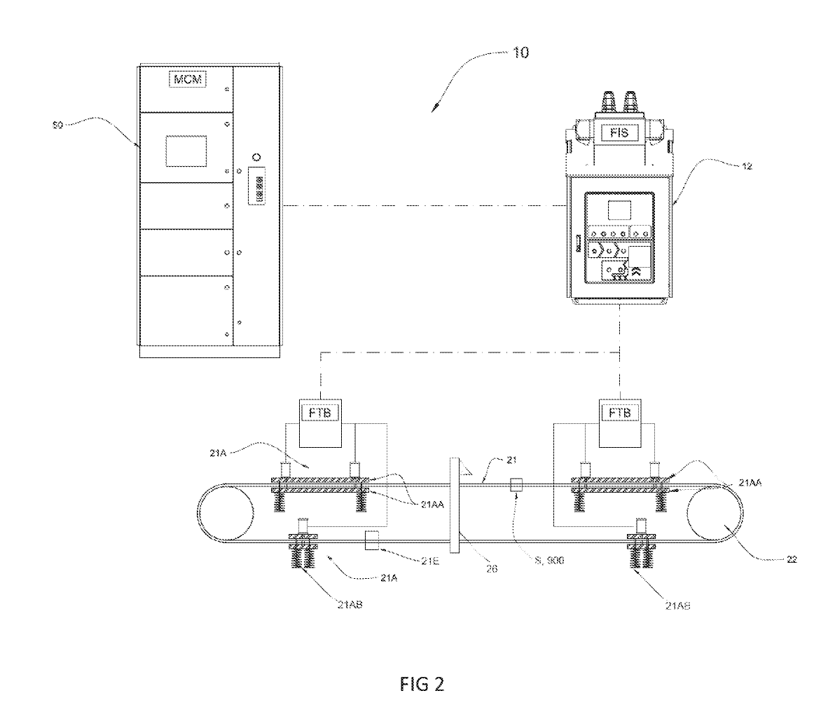

FIG. 2 shows a schematic view of the conveyor belt system shown in FIG. 1, the conveyor belt including an automated conveyor belt clamp system integrated with the equipment isolation system.

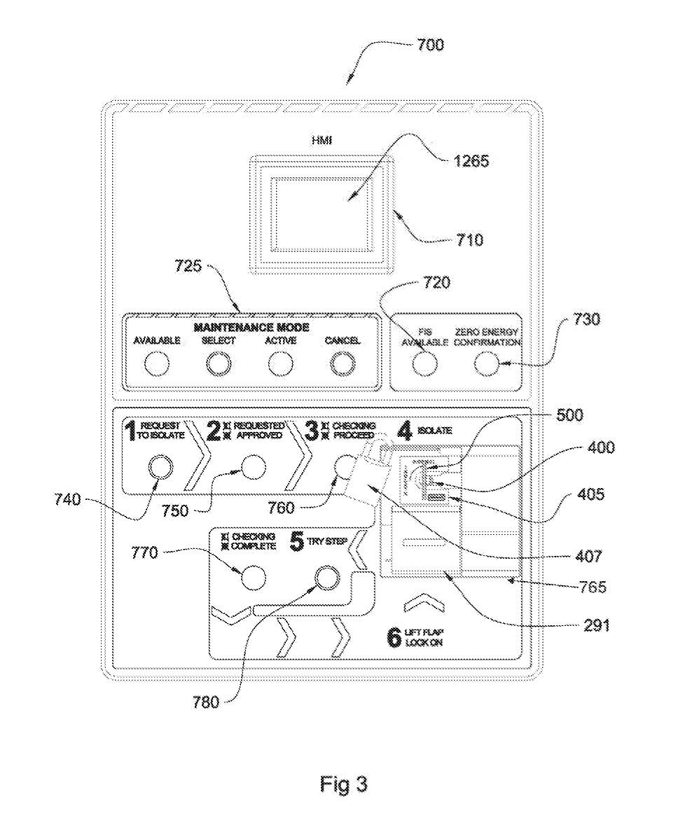

FIG. 3 shows a control panel provided inside a remote isolation station as shown in FIGS. 1 and 2 with the conveyor belt system with its associated isolation lockout switch in normal position.

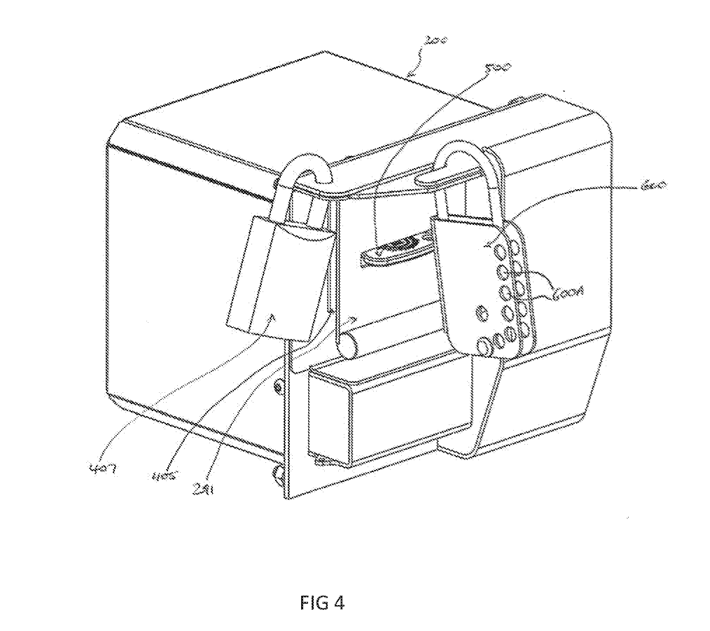

FIG. 4 shows an isolation lockout switch box used in the control panel of FIG. 3 and showing the isolation lockout switch in isolation lockout condition.

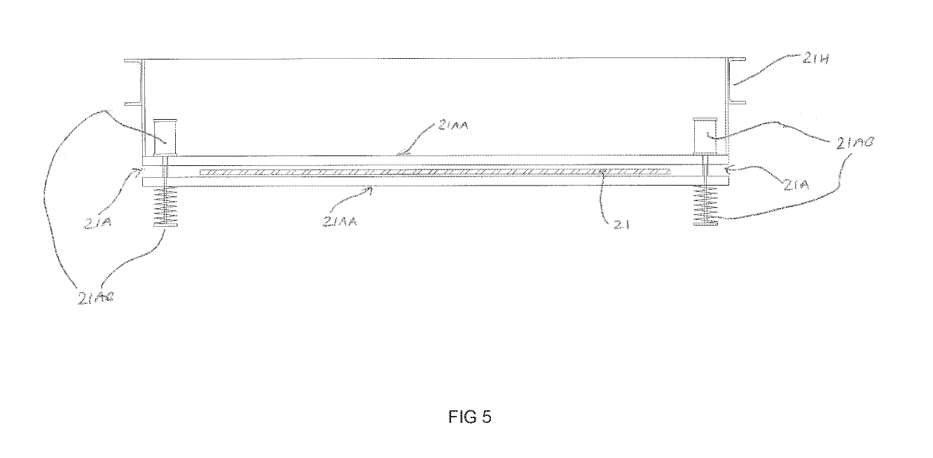

FIG. 5 shows a front section view of the automated conveyor belt clamp arrangement of FIG. 2 with a conveyor belt in unclamped condition.

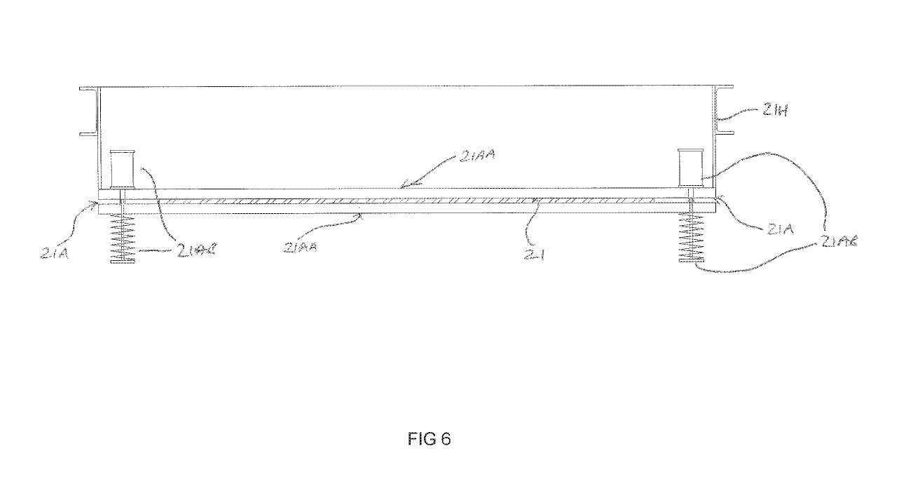

FIG. 6 shows a front section view of the automated clamp arrangement of FIGS. 2 and 5 in clamped condition.

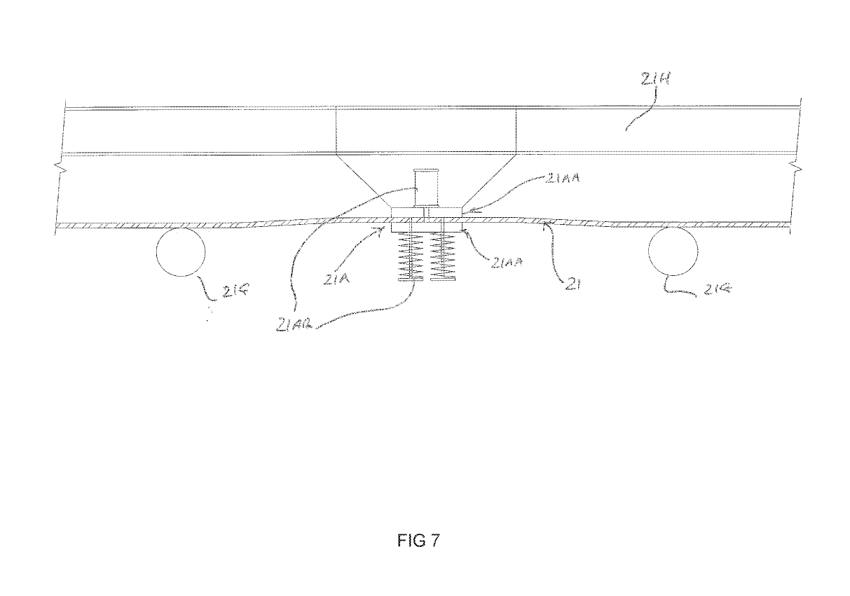

FIG. 7 shows a side section view of the automated clamp arrangement of FIGS. 2, 5 and 6 in clamped condition.

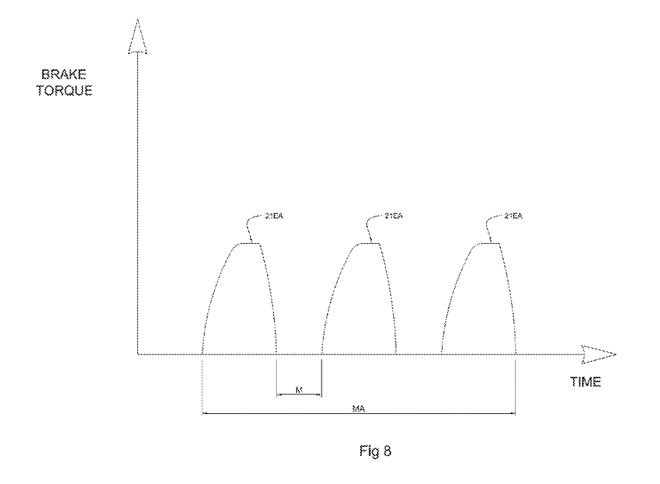

FIG. 8 provides a plot showing braking action prior to isolation of the conveyor belt system by the isolation system shown in FIGS. 1 and 2.

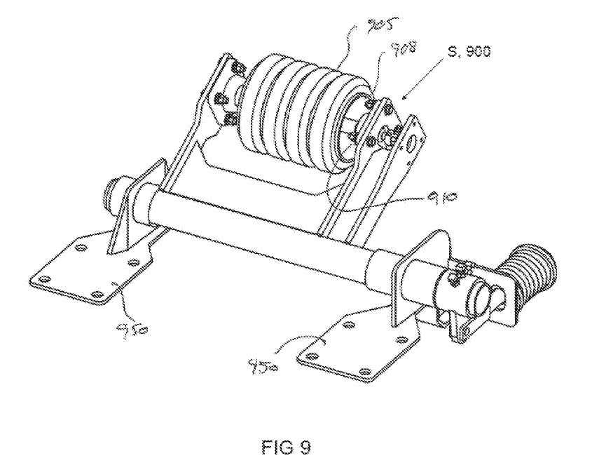

FIG. 9 shows a schematic view of a conveyor belt standstill monitor forming part of the conveyor belt system shown in FIGS. 1 and 2.

Referring to FIG. 1, there is shown a schematic layout of a remote equipment isolation system 10, as retrofitted to an existing conveyor belt system 20, for example a long range conveyor system for conveying iron ore from a mine site to a port for shipment. The conveyor belt system 20 comprises a troughed conveyor belt 21 actuated by a head pulley motor 22 driven by an electrical supply emanating from electrical contacts 31, whether provided as contactors or circuit breakers. One contact is a standard contactor for “ON”/“OFF” operation of the motor 22. The head pulley motor 22 is powered through a Variable Speed Drive (VSD) which is electrically powered from a 3 phase AC power supply line 23 providing voltages of less than 1000V AC. The electrical power is supplied from a sub-station 30. The sub-station 30 houses the contacts 31. Activation of the contacts 31 (i.e. placing them in the “off” or “break” state), de-energises all 3 phases of the electrical supply to the conveyor head pulley drive motor 22. Such de-energisation is continuously monitored by a voltage monitor relay located downstream of contacts 31, i.e. on the conveyor belt system 20 side of the contacts 31.

The conveyor belt system 20 also includes a Tramp Metal Detector (TMD) 21B for detecting tramp metal which requires removal to avoid damage to the conveyor belt 21. Prior to removal of tramp metal, the conveyor belt system 20 requires isolation, as described below, to make removal safer. Isolation may also be required to enable general conveyor belt maintenance including belt splicing.

The conveyor belt system 20 and sub-station 30 are under the control and supervision of a plant control system 260 having a Central Control Room (CCR) 40, via a Distributed Control System (DCS), Programmable Logic Controller (PLC) and a Supervisory Control and Data Acquisition System (SCADA), as are commonly used and would be well understood by the skilled person. Item 41 in FIG. 1 is representative of a communication and control network between the CCR and the various other plant and isolation systems and components. A Control Room Operator (CRO) 42 is located within the CCR 40 and has various Input/Output (I/O) devices and displays available for the proper supervision and control of the conveyor belt system 20. Except for the remote isolation system 10, the above description represents a conventional system as would be known within the materials handling and mining industries.

The remote isolation system 10 comprises fixed remote isolation stations 12 and 14 which are located proximate to the conveyor belt system 20. Remote isolation stations 12 and 14 include control panels 700 for use in operating the remote isolation system 10. Each control panel 700 is integrated with a dedicated isolation switch box 200 as shown in FIG. 4 and isolation lockout switch 400 as shown in FIG. 3 for completing isolation of conveyor belt system 20 as described below. It will be understood that remote isolation stations 12 and 14 could be replaced or supplemented by one or more mobile isolation stations, for example in the form of portable computer devices (in certain applications these potentially being provided as smartphones) or communication devices using wireless communications, as disclosed for example in the Applicants Australian Provisional Patent Application Nos. 2015902561 and 2015902562, the contents of which are incorporated herein by way of reference. The remote isolation stations 12 and 14 may be powered from the plant grid, other power networks or alternative power sources, conveniently such as via solar power.

The remote isolation system 10 also includes a master controller 50 incorporating a Human/Machine Interface (HMI) in the form of a touch sensitive screen 51 which displays human interpretable information. The master controller 50 is also located within sub-station 30. Remote isolation stations 12 and 14 are in communication with the master controller 50 and each other via communication channels such as channels 11 and 13. These communication channels can be provided in any suitable form including hard wired or wireless forms that satisfy known industrial open communication protocols with Ethernet communications being particularly preferred to enable flexible system updating. Communications must be via safety rated communications protocol software, noting that these may be varied depending on the PLC platform used. For example, the Interbus Safety or PROFIsafe software solutions provide an indication of existing systems which are well known within the mining and materials handling industries. This will ensure that the communication channels are monitored and diagnostic tools are available for fault control and rectification when required.

Further description of the electrical layout and operation of the remote isolation system 10 is provided in the Applicant's granted Australian Patent No. 2010310881, the contents of which are incorporated herein by way of reference. Advantageously, the remote isolation system 10 includes additional features for maintaining isolation integrity as described in the Applicant's Australian Provisional Patent Application No. 2015902556, the contents of which are incorporated herein by way of reference. Some monitoring features are described further below.

In summary, the conveyor belt system 20 is isolated, following tripping of the Tramp Metal Detector (TMD) 21B by tramp metal, by a process involving:
An operator request at remote isolation station 12 or 14 for the control system to approve isolation of all or part of the conveyor belt system 20 including conveyor belt 21 and drive motor 22 in accordance with a preferred mode of isolation developed by the Applicant and described in Australian Provisional Patent Application No. 2015902558, the contents of which are incorporated herein by way of reference;
Isolation being approved if the operator request meets permissives for isolation, for example as described in the Applicant's granted Australian Patent No. 2010310881;
A try start process being invoked to check that the isolation is effective, which involves checking that electrical contacts for the conveyor belt system 20 are in an isolated position with no voltage being detected by the voltage monitor relay downstream of the electrical contacts 31; an attempt to re-start the conveyor belt system 20 using a manual switch or automated process; and checking that there is no re-energisation of conveyor belt system 20 (for example as continuously monitored by conveyor belt 21 movement as sensed, both prior to and during isolation, by a conveyor belt 21 belt movement sensor S and as described below); and
Lockout at a control panel of remote isolation station 12 and/or 14, with the isolation lockout switch 400 as shown in FIG. 3 of isolation switch box 200 as shown in FIG. 4, if the try start process is unsuccessful (as required) and stored energy tests show that, for all practical safety purposes, energy has dissipated from the conveyor belt system 20 and the remote isolation system 10 can proceed to isolate.

Further description of the isolation as effected on the conveyor belt system 20 refers only to remote isolation station 12 but is to be understood to be equally applicable to remote isolation station 14.

The isolation procedure requires dissipation of energy which could cause safety hazards from undesirable movement of the conveyor belt 21. The conveyor belt system 20 includes a brake 21E which is activated to bring the conveyor belt 21 to a stop. At least one stored energy test is then performed to ensure that conveyor belt 21 is stationary and that stored energy has been released. The conveyor belt movement sensor S, (such as a belt standstill monitor as described below) which can sense motion in forward and reverse directions of conveyor belt 21 travel, is used to ensure that the conveyor belt 21 has come to a complete stop before isolation has been completed. The conveyor belt sensor S could be provided together with or as a belt standstill monitor (BSM) 900. For example, plant control system 260 may command release of conveyor brake 21E and then the conveyor belt 21 may again be monitored for movement by speed sensor S. Such monitoring is continuous. When the conveyor belt 21 is confirmed stationary with zero speed sensed by sensor S, the brake 21E will be applied. The brake 21E will then be released again with the conveyor belt 21 being again monitored for movement by sensor S. This procedure may be repeated as many times as necessary until sensor S and consequently the plant control system 260 confirms that the conveyor belt 21 remains stationary with all stored energy released or dissipated.

This process may be demonstrated with reference to FIG. 8 showing a plot of brake 21E action, as reflected by brake torque, against time. Here brake 21E is applied in three pulses 21EA, of approximately equal length, with speed monitor S continuously monitoring movement at all times including during time intervals M between brake pulses 21EA. When no movement is sensed by speed monitor S after three pulses 21EA (corresponding with a certain elapsed time MA), plant control system 260 sends a signal to control panel 700 that the operator may proceed to isolation switch lockout as described below.

FIG. 3 shows a schematic of a control panel 700 located within the remote isolation station 12. Panel 700 has a Human Machine Interface (HMI) 710 with a touch screen 1265 (though less fragile buttons, switches and other input devices may be used in alternative arrangements) for entering commands including issuing isolation requests to the plant control system 260) and other commands. A request button 740 is provided for isolation requests. Information can also be presented on screen 1265 in respect of any such isolation requests including isolation status and other plant information. Control panel 700 also includes:
indicator light 720 showing whether or not the remote isolation station 12 or 14 is available for isolation;
indicator light block 725 showing whether or not exclusive control or maintenance mode is active as described in Australian Provisional Patent Application No. 2015902557; the contents of which are incorporated herein by way of reference (i.e. remote isolation station 12 exclusively controls conveyor belt system 20 and typically the stopping and starting of conveyor braking system 21E as described below; and respective “select” and “cancel” buttons for initiating or terminating the exclusive control or maintenance mode);
indicator light 730 for indicating zero energy confirmation when sensors, such as the voltage monitor relay described above and belt speed sensor S indicate zero hazardous energy in the conveyor belt system 20;
request isolation button 740 which is activated by an operator (and which illuminates when pressed) to request isolation and “request approved” indicator light 750 which illuminates to provide status information to said operator;
indicator light block 760 for showing correctness of selection of conveyor belt 21 for isolation and for indicating that control system checking is taking place subsequent to an isolation request being instigated;
indicator light block 770 for showing whether or not the isolation process is complete following control system checking;
try step button 780 for requesting a try start as described above; and
isolation switch block 765 with isolation lockout switch 400 (shown with key 500 in a normal position with keeper plate 405 locked by padlock 407 to prevent removal of key 500 from the isolation lockout switch 400. Isolation lockout is further evident with reference to FIG. 4 showing the isolation switch box 200 detached from control panel 700. Lockout switch 400 has key 500 in isolated position with flap lock member 291 in correct position application of hasp 600 securely and correctly accommodated for isolation lockout. Multiple operators may need to lockout applying their own hasps to hasps 600 using apertures 600A).

The control panel 700 also includes graphics (in the form of arrows and text) illustrating the sequence of steps to be followed in the required isolation procedure.

Further description of the construction and operation of the lockout switch box 200 is provided in the Applicant's Australian Provisional Patent Application No. 2015902554, the contents of which are incorporated herein by way of reference.

Remote equipment isolation system 10 provides additional security to those working on conveyor belt system 20 and conveyor belt 21, to perform tasks such as tramp metal removal and conveyor belt splicing. Conveyor belt 21 is provided with an automated conveyor belt clamp system, as shown in FIGS. 5 to 7 comprising a number of automated belt clamps 21A for preventing belt 21 movement along its intended path for normal operating conditions during isolation. It will be understood that this represents just one possible conveyor belt clamp system that could be used. The number of belt clamps provided is typically dependent on the required holding torque and possible mounting locations available for such clamps. Where appropriate, storm clamps 26 for preventing loss of the conveyor belt 21 from its mountings during storms or high wind conditions could also be integrated with the remote equipment isolation system 10. Furthermore, the belt clamps 21A could also be activated during such storms or high wind conditions together with the dedicated storm clamps 26 to provide additional clamping of the conveyor belt 21 if specific circumstances necessitated such actions.

As shown in FIG. 2, belt clamps 21A are spaced apart on the feed and return sides of the conveyor belt 21. As shown in further detail in FIGS. 5 to 7, the belt clamps 21 are located proximate to conveyor frame (stringer) 21H. Each belt clamp 21A comprises clamping plates 21AA extending transversely across the conveyor belt 21. During normal operation of conveyor belt 21, the clamping plates 21AA have a clearance from the conveyor belt 21 so as not to interfere with its normal or design operation. This open or unclamped position is shown in FIG. 5.

Clamping plates 21AA are brought into compressive engagement with conveyor belt 21 by a drive system 21AB including an electric motor under the control of the plant control system 260. When clamps 21A are engaged against the conveyor belt 21, as shown in FIGS. 6 and 7, the conveyor belt 21 should remain stationary.

Further, considerable time savings may also be achieved by integrating the engagement of belt clamps 21A with operation of the remote isolation system 10 as above described. The belt clamps 21A clamp the conveyor belt 21 by sufficient force to prevent movement. Accordingly, when isolation is approved following successful passing of the try step of the isolation process, plant control system 260 instructs engagement of the belt clamps 21A with the conveyor belt 21 through drive system 21AB using drive mechanisms (of conventional form) as a step in the isolation process. Release of the belt clamps 21A by drive system 21AB is also controlled by plant control system 260. Position of clamps 21A, whether released or engaged, is sensed by a clamp position sensor.

Use of automated, rather than manually installed, belt clamps 21A saves time on conveyor belt maintenance, including for example in respect of belt splicing requirements, and especially maintenance on the conveyor belt brake system 21E and is safer. Manual belt clamps do not need to be transported into place in a potentially cramped and elevated position which may cause safety issues. In addition, the belt clamps 21A do not require manual, or even automatic installation, in separate steps after isolation lockout has occurred and this saves significant time for production. The time saved provides appreciable benefits over current clamp arrangements of which the Applicant is aware.

Use of conveyor belt clamps 21A should prevent movement of the conveyor belt 21, but conveyor belt speed or movement monitoring may also be continuously conducted both prior to and during isolation using speed monitor S to provide further safety assurance by checking that the conveyor belt 21 has come to a complete stop. Position of the clamps 21A is also monitored. Speed monitor 5, which can also or alternatively be provided as a belt standstill monitor (BSM) 900, is shown in FIG. 9, and arranged to operate with the conveyor belt system 10. BSM 900 is ideally mounted, using mounting brackets 950, close to a belt support roller 21G (as shown in FIG. 7) to prevent sagging of the conveyor belt 21 onto the unit. BSM 900 has a rotatable encoder roller 905 which is in contact with conveyor belt 21 and caused to rotate (either clockwise or anti-clockwise) by the movement of the belt 21. As it does so a sensor arrangement 910, such as a Hall effect sensor, co-operates with a sensible index 908 on the encoder roller 905 allowing measurement of the rotational speed (which has a relationship with conveyor belt speed) in the manner of a conventional encoder.

The BSM 900 serves a number of key roles as are described below. Firstly, the BSM 900 is used to qualify one of the primary steps in the remote isolation process, that is, it confirms that the conveyor belt 21 is stationary. This enables a request to isolate by an operator (i.e. effected by pressing the “REQUEST TO ISOLATE” button 740 on the control panel 700) being recognised by the control system when received. Secondly, the BSM 900 is integral to the energy release or energy dissipation sub-routine as described hereinbefore where the conveyor brake 21E is applied and released to find the neutralised (and hence de-energised) position of the conveyor belt 21 prior to isolation. The BSM 900 facilitates continued execution cycles of the brake release routine until no movement is detected in the conveyor belt 21. Thirdly, the BSM 900 is used to continually monitor the conveyor belt 21 for movement at least when a remote isolation is in place and will activate alarms if movement is detected. Importantly, the BSM 900 is configured to be fit for the application purpose of a functional safety system and is designed to withstand the rigours of the installation, which involves actual contact with the conveyor belt 21 to provide direct sensing thereof.

Use of conveyor belt clamps 21A, which would follow conveyor brake isolation 21E in a sequential isolation mode (as described in the Applicant's Australian Provisional Patent Application No. 2015902558) should prevent movement of conveyor belt 21 but conveyor belt movement monitoring is continuously conducted both prior to and during isolation using belt movement sensor S to provide further safety assurance by checking that the conveyor belt 21 has come to a complete stop. If conveyor belt 21 movement is detected, which has very low probability in the system described, alarms can be triggered to alert operators to evacuate and take corrective action.

The equipment isolation system as described above provides a number of benefits, but most notable is that automated belt clamps are built into the equipment isolation system such that clamp engagement and disengagement is more readily combined with isolation events and safe work practices.

Modifications and variations to the equipment isolation system of the present invention will be apparent to the skilled reader of this specification. Such modifications and variations are deemed within the scope of the present invention.

Furthermore, while the control panel 700 has primarily been described as including a human machine interface (HMI) 710 with a touch screen 1265 and a series of buttons and lights (e.g. 740, 750, 760, 770, 780 etc) to enable an operator to request an isolation event, it should be noted that the control panel 700, and specifically the touch screen 1265, may be configured to provide greater control and more information about isolation system steps to an operator (or indeed full control and all information to do with the isolation system). That is, a more ‘digitally’ based input means (or indeed a totally digital system) may be arranged for operation instead of an analogue or part analogue system as described herein to enable control of the equipment isolation system according to the present invention.

1. An equipment isolation system comprising:
at least one equipment item including a conveyor belt energisable by an energy source;
an automated conveyor belt clamp system operable for restricting conveyor belt movement from movement under normal operating conditions as part of the isolation; and
a control system for automatically isolating said conveyor belt from said energy source to an isolated state in an isolation process wherein said control system operates said automated conveyor belt, clamp system as a step in said isolation process.

2. An equipment isolation system as claimed in claim 1 implementing steps to dissipate energy from an isolated, or to be isolated, conveyor belt system through stored energy tests prior to isolation.

3. An equipment isolation system as claimed in claim 1 wherein said control system continuously monitors isolation integrity by monitoring conveyor belt movement and conveyor belt clamp position.

4. An equipment isolation system as claimed in claim 1 wherein said conveyor belt includes a braking system with brake(s) for slowing and stopping conveyor belt movement, said brake(s) being released and applied in a braking cycle procedure during which the conveyor belt is continuously monitored for movement through stored energy testing employing a plurality of sensors until the control system confirms that hazardous stored energy has been released or dissipated, preferably by confirming that the conveyor belt is completely stationary,

5. An equipment isolation system as claimed in claim 1 wherein said at least one sensor, preferably a plurality of sensors, for monitoring isolation integrity is selected from the group consisting of belt speed sensors, belt standstill monitors, belt slack monitors, belt clamp position sensors, braking system temperature sensors and braking system pressure sensors including brake fluid pressure sensors and brake fluid temperature sensors.

6. An equipment isolation system as claimed in claim 1 wherein said isolation process enables conveyor belt cc such as belt splicing.

7. An equipment isolation system as claimed in claim 1 wherein storm clamps are also automated and integrated within the isolation system.

8. An equipment isolation system as claimed in claim 1 wherein said control system approves isolation on permissible request logged by an operator at a remote isolation station.

9. An equipment isolations system as claimed in claim 8 wherein said remote isolation station is a mobile isolation station.
